(19) United States
(12) Patent Application Publication
(10) Pub. No.: US 2013/0024273 A1
(43) Pub. Date: Jan. 24, 2013

(54) Sales & marketing recommendation system

(71) Applicants: Peter Stark, Chester, NJ (US); Peter Robinson, Boston, MA (US)

(72) Inventors: Peter Stark, Chester, NJ (US); Peter Robinson, Boston, MA (US)

(73) Assignee: Whitney, Danforth & Stark Associates, Inc.

(21) Appl. No.: 13/137,066

(22) Filed: Jul. 19, 2011

(51) Int. Cl. G06Q 30/00

(52) U.S. Cl. 705/14.43; 705/14.44

(57) ABSTRACT

A Sales and Marketing Recommendation System comprises one or more software packages designed to run on various hardware platforms (Windows PC, Apple, iPad, Android, BlackBerry, iPhone) and access a secure website, where a corporation's users may configure, initiate, and track marketing and sales activities. Behind the website is a database to track activity occurring within the system, as well as data on activity and customers received from other integrated systems. Additionally, a recommendation engine analyzes the data to constantly provide updated suggestions to the users regarding which customers to target and what messages to use.

### REFERENCE TO RELATED APPLICATION

This application claims the benefit of the filing date of Provisional Application No. [Insert Number], which was filed on [Date].

### BACKGROUND OF THE INVENTION

The present invention relates to the field of software systems, databases, and learning decision logic that support sales and marketing professionals in serving their customers relevant information, services, and products. More specifically, the present invention is a series of software tools, which are used by marketers to define customer segments and generate segmented marketing materials, and which are applied by sales professionals to plan and execute sales calls with customers using recommended materials. The software tools of the present invention also comprise a recommendation engine to learn from the aforesaid activities and make increasingly accurate recommendations to improve the relevancy and value to customers of the information provided by marketers and sales professionals.

Marketers typically produce a variety of advertising or promotional materials dedicated to different types or segments of customers, as well as different communication media channels (in person via a sales professional, in print, television commercials, online, etc.). The task of determining which messages through which channels at what timing and frequency are having the greatest impact on their customers is extremely challenging. To further complicate the marketer's job, they must also determine which segments of the population will respond most favorably to which messages. As a result, marketers rely heavily on market research and analytics to determine the most effective messages and media to reach their target customers, but they must rely on the help of analysts to interpret and act on the available data.

From a sales professional's perspective the challenge is similar except that the scope is more personal. Unlike marketers, sales professionals must determine on an individual customer basis which marketing message is the most appropriate and when and how to deliver it. Marketing messages are handed down to sales professionals in the field by marketers in the home office with the expectation that those messages will be communicated exactly as intended. At the same time, sales professionals cannot influence mass marketing messages that may target their customers.

To use the pharmaceutical industry as an example, marketers and sales professionals must communicate the usefulness and safety of their medicinal products to patients, healthcare professionals, and insurers. To help them decide which potential customers to target, pharmaceutical market researchers analyze prescribing and sales data, insurance formulary status, and patient demographics to make recommendations. When deciding which messages are effective for a given segment of customers, pharmaceutical marketers often rely on focus groups, exposing different segments of customers to multiple messages and phrasings over the course of months before settling on one or two versions of a message that seem to resonate best with the most customers. Here the data is very subjective, rarely conclusive, and expensive to obtain both in time and money.

Marketers and sales professionals currently have several tools at hand to help them capture and make sense of this data. Customer data warehouses track customer activity, preferences, and sales. Sales force automation systems track sales professional interactions with customers, while campaign management systems execute timed email and direct mail campaigns and track customer responses. Websites measure clicks, time on page, and user abandonment rates. Analytical modeling tools help find trends in the copious data. Closed loop marketing systems allow sales professionals to interact with their customers, while recording which messages are used and, in more advanced systems, how those messages are received. All of these systems unfortunately exist in silos with poor integration, meaning that the same customer's preferences and history are not available in one single place. Moreover, at their core these systems are simply massive databases that require the users themselves (marketers and sales professionals) to analyze the data in order to find useful insights that will help them work with their customers.

The present invention provides a software application backed with a database that tracks activity with customers across all media, and a decision engine that analyzes that information, applies business rules, and provides recommendations directly to the marketer or sales professional. The invention combines the functions of existing sales force automation, closed loop marketing, analytical modeling, and some of the features of campaign management with a unified and simplified user interface so as to allow users to have access to all needed customer and message information in one location. More importantly, the recommendation engine eliminates the need for marketers and sales professionals to do their own analysis of the data by providing recommendations on which customers to target at what time and with what message. The marketer or sales professional is empowered to override a recommendation based on personal knowledge, and the recommendation engine will track such overrides and use them to make better recommendations in the future.

### SUMMARY OF THE INVENTION

The present invention comprises one or more software packages designed to run on various hardware platforms (Windows PC, Apple, iPad, Android, BlackBerry, iPhone) and access a secure website, where a corporation's users may configure, initiate, and track marketing and sales activities. Behind the website is a database to track activity occurring within the system, as well as data on activity and customers received from other integrated systems. Additionally, a recommendation engine analyzes the data to constantly provide updated suggestions to the users regarding which customers to target and what messages to use.

Users of the secure website can view detailed customer information, including relevant biographical information, such as location, availability, and job title, as well as sales and activity history and any upcoming planned promotions through media channels that target the customer. The list of customers available for viewing by any one user is based on permissions. For example, a sales professional may only have access to view the customers in that sales professional's geographical territory, while an individual marketer may only be able to see customers belonging to a specific market segment. Access rights in the secure website are configurable in turn by administrators.

Users can similarly view information about any available marketing messages and tactics. Information about messages may include the actual copy of the message, intended usage, recommended target audience, similar messages, and the historical and planned uses of the message with the user's customers.

Sales professionals using the invention will be presented with recommendations of which customers to call on any given day and will be able to plan their daily call routes based on this information. Sales professionals may be allowed flexibility in accepting or ignoring customer call recommendations based on configurable privileges. For example, senior sales professionals may be given full freedom to choose their call routes, while more junior sales professionals may be required to call on specific targeted customers. Whomever the sales professional actually sees, the software will record the activity and use it to refine future recommendations.

Sales professionals may also be alerted by the software, via SMS messages or emails, that they need to interact with the system in some way. For example, a customer may request information about a specific product on the corporation's website, and that request may be routed to the sales professional for fulfillment, whereupon the software will notify the sales professional that activity is requested. Sales professionals may respond directly to the notification and may also access a list of all pending and completed alerts within the present invention's website or mobile application.

Sales professionals may customize presentations to use with customers using the present invention's website. The recommendation engine of the present invention will provide to the sales professional a suggested presentation based on the targeted customer. Within the bounds of configurable rules, the sales professional may be able to alter the presentation's contents. For example, senior sales professionals may be able to fully change the messaging in the presentation to the point of entering new text or graphics, while junior sales professionals would only be allowed to choose between pre-built presentations. More commonly, a sales professional may choose to exchange pre-built versions of a message within a presentation. For example, the invention's website might contain a presentation that allows the user to choose between a slide that shows a message using a graph and one that shows the same message using a data table. Presentation customization can also be subject to a variety of business rules set by the corporate marketing, legal, and regulatory departments. Examples of such business rules may include requirements as to presentation of messages in a certain order, inclusion of a disclaimer message in every presentation, or allowance of only one version of a message within the same presentation.

Sales professionals may also choose to customize order parameters for a potential order that will be included as part of the presentation. Typical order parameters could include the minimum and maximum number of units to provide, the contents of the order, or price points. For example, a sales professional may include a free patient information brochure request form as one of the messages in a planned presentation for a healthcare provider concerning a pharmaceutical product, and then pre-configure the number of brochures that will initially be displayed as available, as well as the maximum number that will be offered should the healthcare provider request more.

Upon finishing the customization of a presentation using the present invention, the sales professional may either save the presentation for personal delivery when the sales professional visits the customer, or they may instead publish it to a corporate website while inviting the customer via email to view the presentation. Sales professionals and marketers may also be able to publish presentations as brochures, posters, emails, or other media that are sent directly to customers. If presentations are published to media channels with a cost (typically print but potentially other channels as well) the sales professional will need to have sufficient budget available and possibly may require management approval for the expense.

When customers receive the presentation, whether as a personal conferral by a sales professional, as an online interactive presentation, as a paper brochure, or by any other means, the software of the present invention records, at a minimum, the delivery of the presentation, and depending on the channel, exactly which messages the customer viewed and for how long. By measuring message receipt, interaction, and reaction, the present invention's recommendation engine is able to better segment customers and provide more relevant message recommendations.

For presentations delivered in person by a sales professional, the sales professional uses a tablet or slate PC, such as an iPad, to present the configured messages to the customers. The sales professional can navigate through the planned messages using simple finger swipes or taps, but may also respond to customer inquiries by navigating out of the planned presentation, with the ability to return to the planned presentation later. In this medium, the sales professional also has the ability using the invention to record perceived customer reaction to specific messages during the presentation by using input gestures on the device.

Sales professionals can also use this invention to present to customers live over the internet, in an online conference mode, by which the sales professional is able to display the presentation and a video feed of the sales professional over the internet to the customer. Customers can access this medium after either being invited by a sales professional to an online meeting, or by requesting a meeting using a separate corporate website. In this medium, the sales professional has access through the secure website to two views of the presentation. One view displays what the customer sees, but enables the sales professional to activate dynamic content within the presentation. In the other view, which only the sales professional can see, the sales professional can choose to record feedback or modify the upcoming flow of messages.

Following the customer presentation, the sales professional can alter details of the recorded presentation, such as the audience of the presentation and the reactions to specific messages presented during the presentation. The sales professional may also record any expenses incurred as part of the presentation and tie those expenses back to specific customers. These expenses can be collected elsewhere in the secure website of the present invention to create an expense report for submission, approval, and reimbursement.

Marketers can perform many of the same activities as sales professionals, including customizing presentations and targeting them to customers. Marketers using the present invention this way will typically be customizing email, online, or print presentations intended for a mass audience and will not be individually rating feedback. Marketers can also use the invention to plan the criteria for different customer segments, based on recommendations from the invention's recommendation engine, as well as to formulate the different messages to be presented to each customer segment, along with the timing of such messages. As the present invention gathers more feedback from customer behavior over time, it is able to assume more responsibility for segment planning and message recommendations from the marketer, while still allowing the marketer to override recommendations.

The present invention further can be configured to provide operational alerts to marketers or operations users. These alerts may recommend such actions as adjusting business rule thresholds to optimize marketing expenditures or altering sales professional territory coverage.

Lastly, the present invention provides a variety of dashboards to allow sales leadership, marketing, and operations to track system usage and message recommendation impact. Users can alter the filter and sorting criteria of the different dashboards to track performance at a more or less granular level.

To perform its functions, the present invention must integrate and share data with multiple third-party systems. Depending on the client implementation, these third-party systems may have greater levels of control. For example, a user of the present invention with an existing and satisfactory sales force automation system may choose to use the existing capabilities of that system instead of the complementary ones in the present invention, relying on the present invention only for its recommendation engine and presentation capabilities. The present invention is able to interface with such third-party systems through a streamlined interface configuration tool that allows a business user without skills in computer programming to configure the timing and content of data file interfaces or direct database links. Users can graphically associate data feeds from third-party systems with their equivalents in the present invention, and the invention will handle the necessary data transformations and scheduling.

Having described the general concepts of the present invention, it is understood that the invention may be realized in a number of possible embodiments. While one of these embodiments has been selected to illustrate in more concrete form how this invention may be practiced, it is understood that the following detailed description is presented for exemplary purposes only and does not limit the scope of the present invention or the claims made in relation thereto.

### BRIEF DESCRIPTION OF THE DRAWINGS

FIG. 1 is an exemplary system architecture showing the invention's components and relationships to each other, as well as to likely third-party systems with which the invention will integrate.

FIG. 2 is an exemplary process flow describing how marketers, sales professionals, and customers interact with the website user interface of the system to customize, present, interact, record, analyze, and recommend messages.

### DETAILED DESCRIPTION OF THE PREFERRED EMBODIMENT

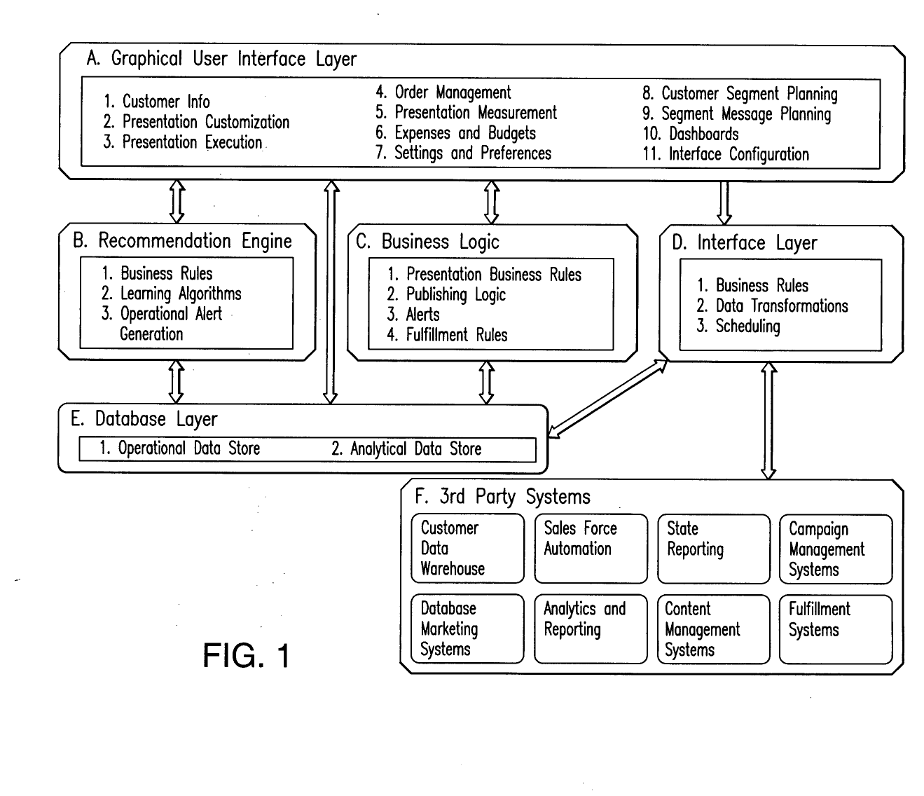

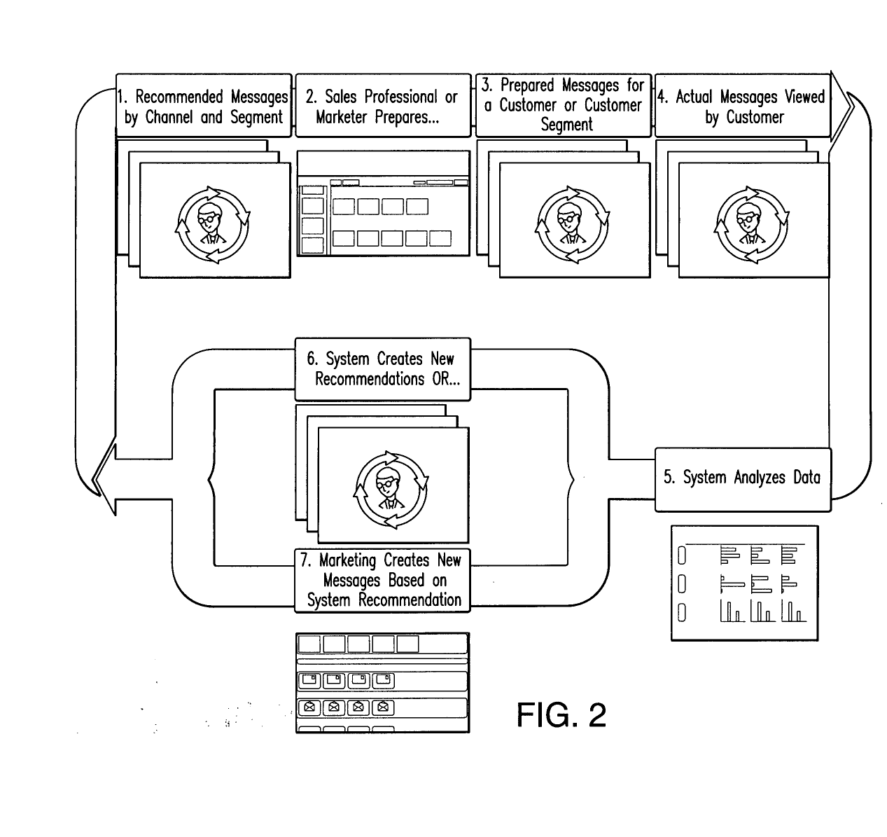

FIG. 1 describes an exemplary system architecture of the invention, with major components, sub-components, and data flows exposed. The Graphical User Interface Layer A includes the different user facing components accessible through the invention's secure website, either on separate web pages or combined as needed to make the users' tasks as easy and simple to execute as possible. Users with sufficient permissions can access subcomponents A.1-A.11 of the Graphical User Interface Layer A to perform the tasks detailed in FIG. 2.

The Recommendation Engine B and its subcomponents B.1-B.3 make recommendations regarding target customers, messages, and channels to the users interacting with the subcomponents of the Graphical User Interface Layer A.

The Business Logic Layer C comprises the subcomponents C.1-C.4, which encompass the processing logic to handle customizing presentations within business guidelines (subcomponent C.1), publishing message content to different channels (subcomponent C.2), alerting users when action is required (subcomponent C.3), and processing order fulfillment requests (subcomponent C.4).

The Interface Layer D can be configured by users through the Graphical User Interface A to accept data from or send data to the 3^{rd} Party Systems F, using data in the Operational Data Store of E.1.

FIG. 2 depicts the exemplary comprehensive lifecycle that messages travel as they progress through the system. In the first step 2.1, messages are organized in the Database Layer (shown architecturally as E in FIG. 1) in ordered bundles and are linked to the customer segments and channels pre-determined by the system to be the most receptive. Messages here are represented by different assets that can convey the message in a particular channel (e.g. web content, print material, etc.). In the second step 2.2, the Sales Professional (for messages targeted to individuals or small groups of customers) or the Marketer (for messages targeted to a mass audience) reviews the recommended messages for the customer segment and channel and uses the system website to customize the messages (referring to FIG. 1, using subcomponent A.2 of the Graphical Interface Layer A for all messages and subcomponent A.4 for ordered materials), limited by any business rules present in the system (enforced by subcomponent C.1 of the Business Logic Layer C of FIG. 1). The result in the third step 2.3 is the prepared messages for a customer or customer segment.

Whether the customer views a presentation guided by a Sales Professional (using subcomponent A.3 of the Graphical User Interface Layer A of FIG. 1) or interacts with the messages through other means (after the messages are published using the tools in the Business Logic Layer C, subcomponents C.2 or C.4, in FIG. 1), the actual messages presented to the customer, along with any interactions and feedback received from the customer, are captured in the fourth step 2.4. Feedback captured by a Sales Professional uses subcomponent A.5 of the Graphical User Interface Layer A in the system architecture depicted in FIG. 1. The data, from recommended message, prepared message, actual message, and any feedback generated, are analyzed in the fifth step 2.5 by the Learning Algorithms subcomponent B.2 of the Recommendation Engine B (in FIG. 1) as it looks for unknown correlations and changes in customer behavior.

In the sixth step 2.6, the system creates new recommendations based on existing business triggers or on its own adaptive analytics (respectively, subcomponents B.1 and B.2 of the Recommendation Engine B in FIG. 1). Alternately, in the seventh step 2.7, marketing can make its own independent changes to messaging using the configuration tools of the Graphical User Interface Layer A (subcomponents A.8 and A.9 in FIG. 1), based on recommendations from the Recommendation Engine B (subcomponent B.3 of FIG. 1) or other data. The new recommendations are stored in the database, and the cycle begins again.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A comprehensive marketing and sales system, having a system architecture which handles marketing and sales messages directed to one or more customer(s) or customer segments through one or more message channel(s) by one or more user(s) of the system, the system comprising:
(a) a first database comprising an operational data store to be used by the system, wherein the operational data store can include customer information, sales data, market data, marketing history data, marketing message exposure, sales history data, content metadata, sales force data, user role and permission data, expenditure and expense data, order data, and business rule metadata;
(b) a second database containing the same data as the operational data store of the first database, wherein the second database is configured to function as an analytical data store, used for reporting and trend analysis;
(c) an analysis means, by which information in the second database is automatically analyzed to determine correlations and trends linking marketing messages and channel preferences to customer purchasing behavior, and by which such correlations and trends are used to generate recommended messages targeted to one or more specific customer(s) or customer segment(s);
(d) one or more software programs, capable of running on one or more hardware platforms of one or more computer device(s) operated by the user(s), wherein the software program(s) display(s) a web-based graphical user interface and access(es) content and data files stored locally on the computer device(s);
(e) wherein the system architecture comprises one or more customer information screens, whereby the user(s) can access customer information, which information can include addresses, phone numbers, email addresses, websites, account affiliations, purchasing history, event attendance history, message receptivity, marketing message channel preference, segmentation, and next recommended activity;
(f) wherein the system architecture further comprises one or more message customization screens, whereby the user(s) can review one or more recommended message(s) for one or more customer(s) or customer segment(s), and wherein the user(s) can customize the message(s) within system-enforced guidelines by reordering assets comprising the message(s), adding or removing one or more message assets, or altering the content of specific assets, and wherein the user(s) can save or publish the customized message(s);
(g) wherein the system architecture further comprises one or more message display screen(s), whereby the customized message(s) are personally presented by the user(s) directly to the customer(s), and whereby the user(s) may navigate on the computer device(s) within and between one or more of the customized messages by using gestures of a mouse peripheral, tablet stylus peripheral, or a finger on a touch-sensitive device, and whereby the user may record customer feedback on a particular customized message or asset thereof, using non-navigational gestures over relevant message content on the computer device(s); and
(h) wherein the system architecture further comprises one or more remote display screens, whereby the customized message(s) can be simultaneously viewed both by the user(s) on the computer device and by the customer(s) using a remote computer at a different location, wherein the computer device and the remote computer communicate via the internet, and whereby the user(s) may navigate on the computer device(s) within and between one or more of the customized messages by using gestures of a mouse peripheral, tablet stylus peripheral, or a finger on a touch-sensitive device, and whereby the user may record customer feedback on a particular customized message or asset thereof, using non-navigational gestures over relevant message content on the computer device(s).

2. The system according to claim 1, further comprising a means by which the user(s) can publish the customized messages, either as an email to the customer(s), or as a website accessible to the customer(s), or to a printer for custom printing and shipping to the customer(s).

3. The system according to claim 2, wherein the system architecture further comprises one or more message review screen(s) whereby a user can review the customized messages used during a customer interaction, remove messages that were erroneously recorded, review customer feedback recorded during the interaction, and alter or record new feedback on each message or asset thereof.

4. The system according to claim 3, wherein the system architecture further comprises one or more expense screens, whereby the user(s) can record items purchased for use with the customer(s), as well as the cost of such items and the customer(s) involved, and whereby the user(s) can aggregate individually recorded purchase items into an expense report and submit the expense report for approval, and whereby management users can reviews and approve or reject expense report.

5. The system according to claim 4, wherein the system architecture further comprises one or more marketing screens, whereby marketing users may review and modify existing customer segmentation, create, alter, or remove segments, enter or modify segmentation inclusion criteria, associate or remove the associations between specific messages and customer segments, and create or alter the timing and criteria by which messages are to be recommended or published for use with the associated customer segments.

6. The system according to claim 5, wherein the system architecture further comprises one or more upload screens, whereby authorized users can upload and describe new content files to be used in messages within the system, and whereby authorized users can bundle messages into sets of recommended messages.

7. The system according to claim 6, wherein the system architecture further comprises one or more business rules screens, whereby authorized users can enter or modify rules used by the system to govern what messages must always be used as part of a set, which messages may be removed, which messages must be used together, which messages must be used in order, and which messages may not be used together in the same set.

8. The system according to claim 7, wherein the system architecture further comprises one or more administration screens, whereby one or more system administrator(s) can set permissions and roles for the user(s), and whereby the administrator(s) can configure system rules for handling the timing and processing of data files received from or sent to other systems, including any data transformations required to input data from such files systematically into the system's databases or to retrieve data systematically from the databases.

9. The system according to any one of claims 1-8, wherein the system further comprises one or more first computational means, whereby the system displays any of its data in customizable reports to the user(s) in one or more data screens.

10. The system according to any one of claims 1-8, wherein the system further comprises one or more second computational means, whereby the system uses analytical processing to find correlations and trends in the sales history data and marketing message exposure and customer feedback to generate recommendations regarding customer segmentation, messages and message channels.

11. The system according to claim 9, wherein the system further comprises one or more second computational means, whereby the system uses analytical processing to find correlations and trends in the sales history data and marketing message exposure and customer feedback to generate recommendations regarding customer segmentation, messages and message channels.

12. The system according to any one of claims 1-8, wherein the system further comprises one or more alert means, whereby the system alerts the user(s) to conditions arising in the system, which conditions can include system operational status, customer requests, trend analysis availability, report availability, customer segmentation changes, and message recommendations.

13. The system according to claim 9, wherein the system further comprises one or more alert means, whereby the system alerts the user(s) to conditions arising in the system, which conditions can include system operational status, customer requests, trend analysis availability, report availability, customer segmentation changes, and message recommendations.

14. The system according to claim 10, wherein the system further comprises one or more alert means, whereby the system alerts the user(s) to conditions arising in the system, which conditions can include system operational status, customer requests, trend analysis availability, report availability, customer segmentation changes, and message recommendations.

15. The system according to claim 11, wherein the system further comprises one or more alert means, whereby the system alerts the user(s) to conditions arising in the system, which conditions can include system operational status, customer requests, trend analysis availability, report availability, customer segmentation changes, and message recommendations.
